(19) United States
(12) Patent Application Publication
(10) Pub. No.: US 2024/0181735 A1
(43) Pub. Date: Jun. 6, 2024

(54) ROTARY TABLET PRESS COMPRISING A SUPPORT ASSEMBLY

(71) Applicant: GEA Process Engineering nv, Halle (BE)

(72) Inventors: Bart Verhoest, Halle (BE); Nicolas Robin, Halle (BE); Antonie Van Zegbroeck, Halle (BE)

(73) Assignee: GEA Process Engineering nv, Halle (BE)

(21) Appl. No.: 18/286,325

(22) PCT Filed: Apr. 12, 2022
(86) PCT No.: PCT/EP2022/059803

§ 371 Date: Oct. 10, 2023

(30) Foreign Application Priority Data
Apr. 12, 2021 (EP) 21167903.0

(51) Int. Cl. B30B 11/08; B30B 15/02; B30B 15/08

(52) U.S. Cl. CPC B30B 11/08; B30B 15/028; B30B 15/08

(57) ABSTRACT

A rotary tablet press comprises a support assembly. In the rotary tablet press having a turret, the support assembly comprises a suspension device positioned above a top punch guide of the turret, as seen in the axial direction. The suspension device comprises a carrier plate and at least one connection element connecting the carrier plate to at least one non-rotating part of the turret. The support assembly is used for suspending a number of auxiliary components from the carrier plate. An enclosure may be connected to the suspension device to surround one or more of the elements of the turret.

### TECHNICAL FIELD

The present invention relates to a rotary tablet press comprising a housing including a compression section, a turret including a die disc, a top punch guide, a bottom punch guide, and a plurality of punches, wherein the turret defines an axial direction and a radial direction, the punches being arranged at a predefined radius defining a pitch of the turret, said turret being positioned in the compression section in a position of use of the rotary tablet press, wherein the rotary tablet press further comprises a number of auxiliary components, wherein the rotary tablet press comprises a support assembly for providing support to at least one of said auxiliary components of the rotary tablet press in the axial and/or radial direction.

### BACKGROUND ART

In such a rotary tablet press, the turret is positioned in the compression section in a position of use of the rotary tablet press, i.e. when the tablet press is in working operation. The turret comprises a number of parts or components including a die disc secured between a top punch guide and a bottom punch guide. Alternatively, the die disc is integral with the top and/or bottom punch guide in a one-part, two-parts turret or multi-parts turret. The turret is driven in rotation by means of a spindle coupled to driving means and the entire turret thus rotates during operation. A powder or granular material is fed into the die bores of the rotary tablet press by means of a feeder connected to the press housing. The rotation entails, i.a., that the punches accommodated in the top and bottom punch guides are reciprocated to compress the material to tablets.

In order to carry out a change-over in the production, e.g. from one material to another or from one tablet size or shape to another, or from one press station to multiple press stations, or change-over from single layer to multilayer (such as bilayer or several layers) production, and/or to and from dry-coated tablet production, the entire turret and auxiliary components are traditionally removed in order to clean the turret or to replace the punches and dies in the turret or to install or remove various components (e.g. switch from single layer to double layer). Subsequently, the turret and auxiliary components are positioned back into the compression section and possibly adjusted.

However this arrangement has a number of drawbacks. First, various auxiliary components need to be removed from press, before turret can be removed, which in turn affects the change-over time. Second, auxiliary components can also only be installed if the turret is positioned back in the press housing, in particular said components being accurately positioned regarding the die plate surface.

In order to solve this, solutions have been suggested to remove auxiliary components together with turret. Examples of prior art tablet presses are described in EP 1 050 399 A2, and in WO 03/020499 A1 resulting in EP 1 423 260 B1 to Courtoy and the commercially available tablet press MODUL™ 5 making use of the Exchangeable Compression Module (ECM) concept. However, when the turret is shifted from one press to another, re-adjustment might therefore be needed, again increasing change-over time. Even in the suggested solution, the auxiliary components are however referenced to press housing, in particular the frame thereof, and the position of the components can only be adjusted when the turret is installed inside the press.

In the prior art tablet press described in WO03/020499 A1, the casing and correspondingly the auxiliary components are designed to be “floating” around the turret, i.e. with no fixed linkage between the turret and itself.

Adjustment of components inside press is not easy due to limited accessibility in the press, especially in case of multilayer configuration with several components present in the turret and the housing as such, and also in the case of dry-coated tablets where an intake system is needed to place the cores inside the die bores. This is also the case in prior art apparatus in which the possibility of keeping the compression zone contained and washing the ECM off line is provided, in order to ensure that no cleaning of press housing is needed, hence facilitating fast change-over. However, accessibility and cleanability are not necessarily made more easy, especially when several components are present such as in multilayer production.

In all of the above prior art tablet presses, it is a challenge to ensure that all parts of the rotary tablet press are positioned accurately in order to secure proper functioning. A recent example of prior art setting out to solve this challenge is WO 2015/124958 A1. Here, a bearing assembly is connected to the turret and provides support to at least one auxiliary component of the rotary tablet press and comprises a bearing and a support means for the at least one auxiliary component. The bearing is positioned outside the pitch of the turret in the radial direction. In this way, a reference point relative to the turret is provided. However, this provides for a somewhat complex design and the bearing assembly needs to accommodate the relatively large speed.

Thus, although the above prior art tablet presses provide well-functioning solutions, there is still room for improvement.

### SUMMARY OF THE INVENTION

An object of the present invention is to address the above-mentioned drawbacks, in particular to obtain a reliable supporting device.

This and further objects are achieved by a rotary tablet press of the kind mentioned in the introduction which is furthermore characterized in that the support assembly comprises a suspension device positioned above the top punch guide of the turret, as seen in the axial direction, and that the suspension device comprises a carrier plate and at least one connection element connecting the carrier plate to at least one non-rotating part of the turret. By the provision of a suspension device provided above the top punch guide, the bottom side of the ECM is kept free of any supporting devices. In turn, this improves the cleanability and water draining. The carrier plate may thus be used for suspending a given configuration of auxiliary components from the above and functions as the desired reference point for positioning of such auxiliary components due to its connection via the connection element(s) to the non-rotating part or parts of the turret.

In some embodiments, one or more of the die disc, the top punch guide, the bottom punch guide, and the plurality of punches is/are rotatable part(s), and the at least one non-rotating part is configured to be stationary relative to the rotatable part(s) when the rotatable part(s) rotate, and a plurality of auxiliary components is suspended from the carrier plate of the suspension device.

Presently preferred embodiments and further advantages will be apparent from the subsequent detailed description and drawings.

### BRIEF DESCRIPTION OF DRAWINGS

In the following description embodiments of the invention will be described with reference to the drawings, in which

FIG. 1 shows a perspective view of a rotary tablet press in a first embodiment of the invention;

FIG. 2 shows a perspective view of the rotary tablet press in a second embodiment of the invention;

FIGS. 3 to 5 show perspective views of the rotary tablet press in the first embodiment;

FIGS. 6 to 8 show perspective views of the rotary tablet press in the second embodiment;

FIG. 9 shows a cross-sectional view of the tablet press in the second embodiment;

FIG. 10A shows a cross-sectional view of the tablet press in a further embodiment of the invention;

FIG. 10B shows a cross-sectional view of the tablet press in a further embodiment of the invention;

FIG. 11 shows a cross-sectional view of the tablet press in a further embodiment of the invention;

FIG. 12 shows a cross-sectional view of the tablet press in a further embodiment of the invention;

FIG. 13 shows a perspective view of the rotary tablet press in the embodiment of FIG. 12;

FIG. 14 shows a perspective view of the table press in a further embodiment of the invention;

FIG. 15 shows a perspective view of the rotary tablet press in the embodiment of FIG. 14;

FIG. 16 shows a cross-sectional view of the rotary tablet press in the embodiment of FIG. 14; and

FIG. 17 shows a cross-sectional view of the rotary tablet press in the embodiment of FIG. 14.

### DETAILED DESCRIPTION

The present invention will now be described in more detail hereinafter with reference to the accompanying drawings, in which embodiments of the invention are shown. This invention may, however, be embodied in many different forms and should not be construed as limited to the embodiments set forth herein; rather, these embodiments are provided for thoroughness and completeness.

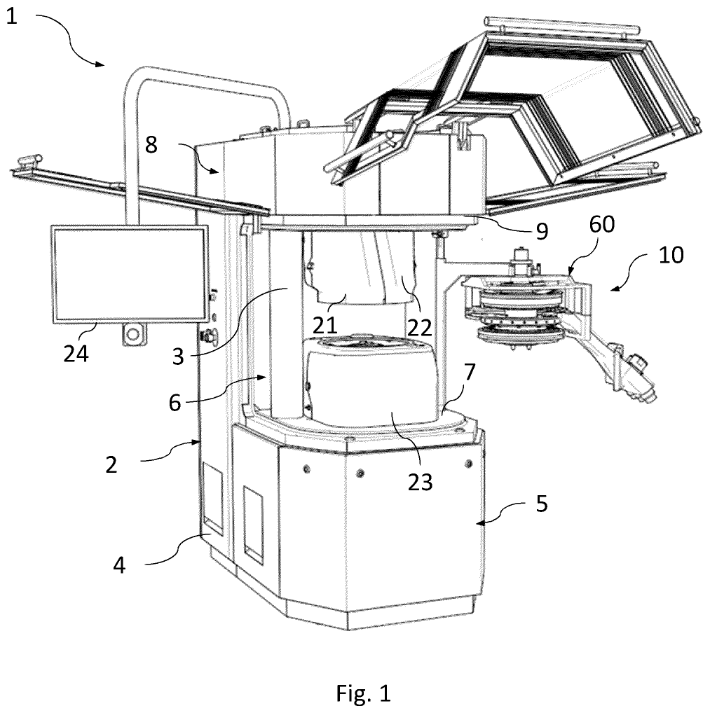

Referring first to the schematic overview of FIG. 1 showing a first embodiment of a rotary tablet press generally designated 1, the rotary tablet press 1 has a press housing 2 comprising a frame 3 and an outer lining 4. The press housing 2 is composed of three sections, which are located on top of each other and are separated by means of partition walls. The lower section, designated the drive section 5, is separated from a central section, designated the compression section 6, by a bottom frame 7 of the press, and the compression section 6 is separated from an upper section, designated the accessory section 8, by a top frame 9 of the press. FIG. 1 further shows caps 21, 22 and 23, which are present to prevent excessive contamination of mechanical parts, and a display 24.

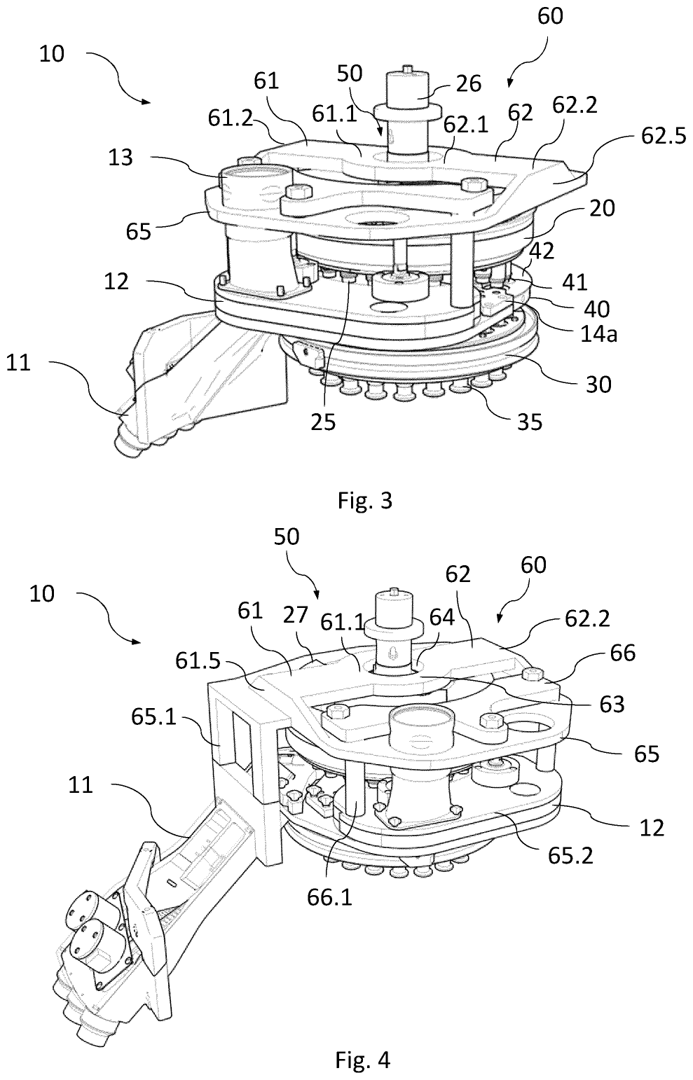

In a manner known per se the housing 2 accommodates a turret 10, parts of which are shown in more detail in FIGS. 3 to 5. During operation of the tablet press, the turret 10 is positioned in the compression section 6 of the housing 2, but may be removed from the compression section 6 in order to allow for instance cleaning, change-over of parts, etc. as indicated in FIG. 1.

The turret 10 comprises a top punch guide 20, a bottom punch guide 30, and a die disc 40 between the top punch guide 20 and the bottom punch guide 30. In the embodiment shown, the die disc 40 is substantially plate-shaped and has a number of bores 41 accommodating a corresponding number of dies (not shown) adapted for forming the tablets to the desired shape and size.

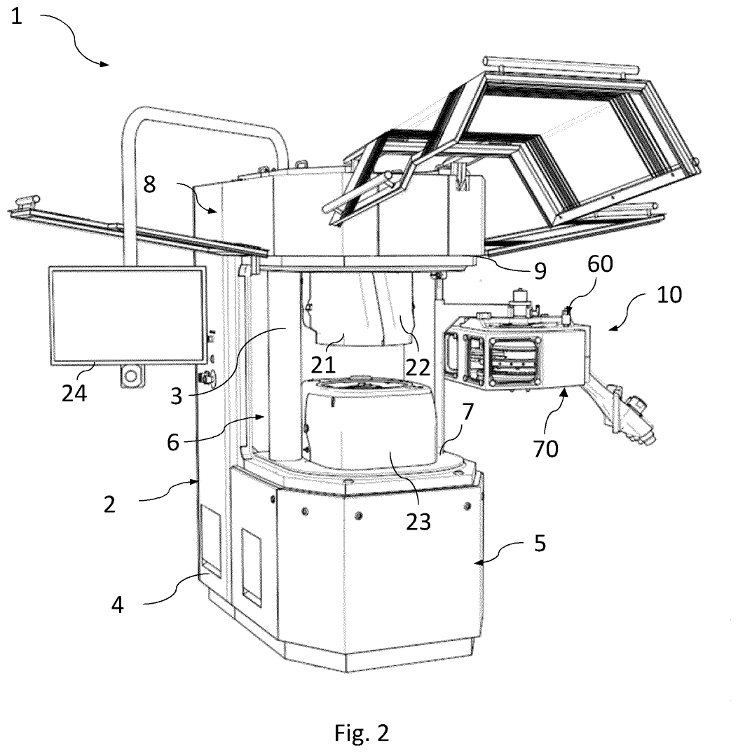

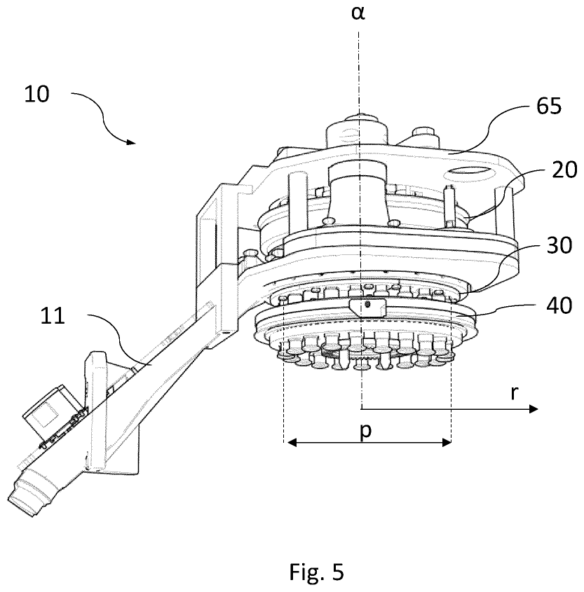

In the embodiment shown in FIG. 2, elements having the same or analogous function as in the embodiment of FIG. 1 carry the same reference numerals. The main difference is that in the embodiment of FIG. 2, an enclosure 70 is provided, in which the turret 10 is located. In the same manner, FIGS. 6 to 8 correspond to FIGS. 3 to 5.

It is noted that only parts relevant to the present invention will be described in detail. For detailed information regarding the operation of a rotary tablet press, reference is made to the above-mentioned WO 03/020499 A1 and WO 2009/112886 A1 (Courtoy). Further reference is made to WO 2015/124958 A1, in particular the embodiment shown in FIGS. 1 to 3 thereof.

Referring also to the FIG. 5, the bores 41 are arranged at a predefined radius defining a pitch p of the turret 10. The bores 41 are evenly distributed along a circumferential line near the outer border of the die disc 40, each bore 41 being arranged with its axis parallel to an axial direction a defined by the turret and coinciding with the vertical rotational axis of the turret. The bore 41 may as mentioned receive a die of a suitable configuration.

The rotating parts of the turret 10 are driven in rotation around a shaft 26 coupled to driving means located within the drive section 5 when the turret 10 is in its position of use. Top and bottom punches 25 and 35 are guided in corresponding guide bores formed in the top punch guide 20 and the bottom punch guide 30, respectively. The punches 25, 35 are accommodated reciprocally in the turret 10 so that a first end of each punch is able to enter a corresponding die, or the bore itself, if no die is present, by displacement of the associated punch in its guide bore, in order to compress material in the die or bore. A second end of each punch 25, 35 is in a well-known manner cooperating with top and bottom cams, respectively, arranged stationarily in relation to the rotating parts of the turret 10 in order to effect axial displacement of the punches by rotation of the turret. The cams are stationary relative to the rotating parts of the turret 10 and only extend along part of the circumference of the turret, namely at that circumferential position where the filling of the material in the bore or die is performed. Outside the extension of the cams, top and bottom pre-compression rollers and top and bottom main compression rollers, respectively, take over the displacement of the punches. Alternatively, compression cams may be used instead of compression rollers for pre- and/or main compression.

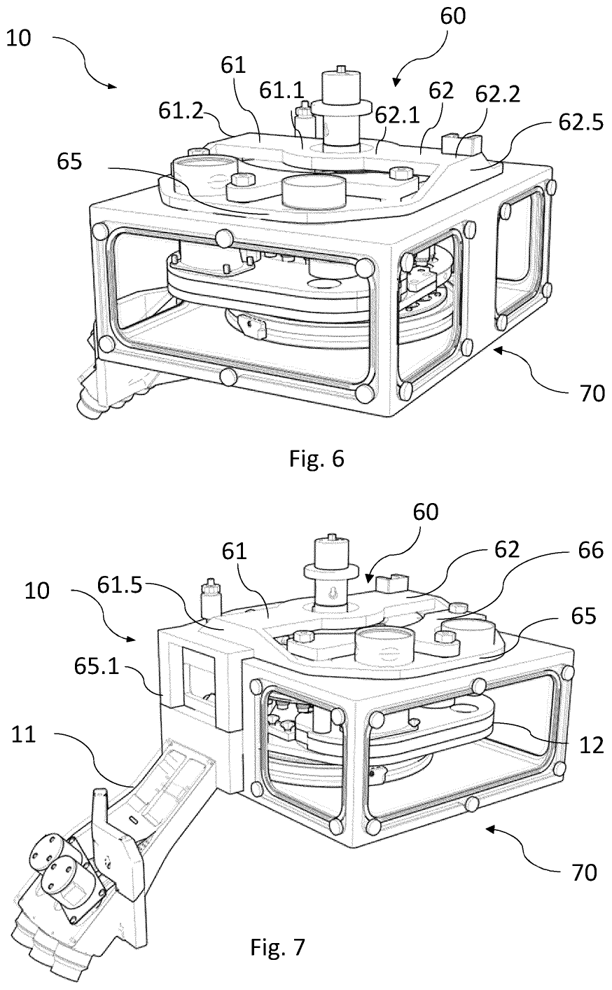

In FIG. 4, a top cam 27 is discernible. For further reference of the rotating and non-rotating parts of the turret 10, confer FIG. 9. Above the top punch guide 20 a stationary disc 28 is positioned in proximity to the top cam 27. Each of these parts is provided with a central bore or aperture for receiving the through-going shaft 26.

In the preceding and following, the turret 10 may be described as being in rotation in use. This, as will be appreciated, refers to that the rotatable part(s) of the turret 10, such as the top punch guide 20, the bottom punch guide 30, the punches 25, 35, die disc 40, and/or further rotatable parts of turret 10 are in rotation. Correspondingly, it will be appreciated that any non-rotating or stationary parts of the turret 10 remain non-rotating or stationary, respectively, also in this case, where the turret 10 is described as being in rotation.

In some embodiments, one or more, such as all, of the die disc 40, the top punch guide 20, the bottom punch guide 30, and the plurality of punches 25, 35 is/are rotatable part(s). Alternatively or additionally, the die disc 40, the top punch guide 20, the bottom punch guide 30, and/or the plurality of punches 25, 35 may be rotating part(s). In some embodiments of the rotary tablet press, the rotatable part(s) is/are configured to rotate about a rotational axis, the rotational axis extending in the axial direction a.

In some embodiments, the turret further comprises a shaft configured to drive the rotatable part(s) into rotation. The shaft may be configured to rotate about the rotational axis. Alternatively or additionally, the shaft may have a shaft rotational axis parallel to the rotational axis.

A number of auxiliary components are provided. A list of such auxiliary components includes, but not exhaustively: a tablet chute 11 protruding from the turret 10 at an angle for conducting away compressed material in the form of tablets from the die bores; a feeder 12 extending in between the die disc 40 and the top punch guide 20, from where it provides the die disc with powder or granules; a powder inlet tube 13 extending in the vertical, i.e. axial direction of the turret, from here powder or granules enter the turret 10 and is fed to the feeder 12. Furthermore, a scraper 14a adapted to scrape off excess powder, thereby ensuring that only the desired amount of powder is present in the die disc is shown. Additional auxiliary components may include an extraction nozzle connected to an extraction tube for extracting dust to a suction system, an ejection finger, a recuperation finger and further cams. Other elements may be present in the tablet press and means for controlling the tablet press according to desired settings may be provided as well.

In the embodiment shown, the single-sided rotary tablet press 1 is adapted for production of single-layer tablets. However, configurations with multiple compression stations, multilayer configurations and configurations for dry-coated tablet production are possible with several feeders, scrapers, compression rollers, ejection stations, core-intake elements etc.

FIGS. 6 to 8 show perspective views of the turret 10 in combination with the enclosure 70 according to the embodiment shown in FIG. 2. In other aspects, this embodiment corresponds to the first embodiment shown in FIGS. 1 and 3-5, in which no enclosure is present. In the following, a support assembly for providing support to one or more of the auxiliary components of the rotary tablet press in the axial and/or radial direction will be described with joint reference to both of these embodiments.

The auxiliary components of the rotary tablet press 1 may as mentioned in the above include the tablet chute 11, the feeder 12 etc., including parts shown and further parts, not indicated, present in such a rotary tablet press 1. The support assembly comprises a suspension device 60 positioned above the top punch guide 20 of the turret 10, as seen in the axial direction a.

The suspension device 60 includes a carrier plate 65 and at least one connection element, here two connection elements in the form of a first arm 61 and a second arm 62, connecting the carrier plate 65 to a non-rotating, or stationary, part of the turret 10. In the embodiments presently described, the stationary part comprises a spacer in the form of a disc (not visible in the perspective views, see FIG. 9), but in principle any non-rotating part of the turret 10 may constitute such a stationary fixpoint. In this way, the auxiliary components may be suspended from the carrier plate 65 which furthermore functions as a reference point relative to the turret 10.

The first arm 61 and the second arm 62 each has a first end 61.1, 62.1 and a second end 61.2, 62.2. In the embodiment shown, the arms 61, 62 are positioned radially opposite relative to each other as seen in the axial direction. Further arms may be provided, or only a single arm could possibly be provided. The first arm 61 and the second arm 62 are connected to each other at a transition portion 63 comprising an aperture 64 co-axial with the axial direction a of the turret 10.

Outer connection portions 61.5, 62.5 of the respective first arm 61 and second arm 62 are provided, such that the outer connection portions 61.5, 62.5 are located at the respective second end 61.2, 62.2. In the embodiments shown, the connection portions 61.5, 62.5 are shaped with an inclination such that the carrier plate 65 is located below the arms 61, 62, as seen in the axial direction, at a distance from a lower face of an intermediate portion of each arm such that an axial gap is formed between an upper face of the carrier plate 65 and the lower face of the intermediate portion of each arm. Here, the suspension device 60 furthermore comprises a clamping plate 66 configured to cooperate with the carrier plate 65 and accommodated in the gap provided. The connection between the carrier plate 65 and the first and second arms 61, 62 is here shown as being an integral connection but may in principle be any suitable mechanical connection.

In the embodiments shown, the carrier plate 65 extends to the outside of each second end 61.2, 62.2, as seen in the radial direction. This makes it possible to suspend auxiliary components located at the periphery of the turret 10 from the carrier plate 65. Thus, for instance the tablet chute 11 is suspended from the carrier plate 65 via a bracket 65.1 depending from the carrier plate 65 in the vicinity of the connection portion 61.5 at the second end 61.2 of the first arm 61. This is visible not only in FIG. 4, but also in FIG. 7 where the bracket 65.1 protrudes even outside the enclosure, as seen in the radial direction. In embodiments including an enclosure, it also conceivable to connect the tablet chute 11, or other auxiliary components, to the suspension device 60 via the enclosure 70 which is directly suspended from the suspension device 60.

Other auxiliary components are suspended within the circumference of the carrier plate 65, cf. for instance the feeder 12 connected to a suspension plate 65.2 which is connected to the carrier plate 65 via a number of rods 66.1 depending from the clamping plate 66 cooperating with the carrier plate 65 as shown in FIG. 4.

FIG. 9 shows a cross-sectional view of the tablet press 1 in the second embodiment of FIGS. 2 and 5 to 8. The non-rotating part is here constituted by a spacer in the form of a stationary disc 28 which has an outer diameter enclosed inside the pitch p in the radial direction r. The stationary disc 28 is interposed between a bearing assembly 50 and the first arm 61 and the second arm 62. The bearing assembly 50 comprises a bearing 51 with a radially inner part 51.1 and a radially outer part 51.2. The radially inner part 51.1 of the bearing 51 is connected to the stationary disc 28. The radially outer part 51.2 is configured to cooperate with the top punch guide 20.

The first end 61.1, 62.1 of each arm 61, 62 is directly in contact with the stationary disc 28. Each first end 61.1, 62.1 is also positioned substantially at the radial position of the bearing 51.

The bearing 51 may be configured to absorb radial and axial forces on the bearing 51 such that the position of any auxiliary components hanging from the suspension device 60 maintain their position relative to the reference provided by the turret 10 itself. Suitable bearing types are well-known to the person skilled in the art and includes but is not limited to four-point-contact ball bearings that provide high accuracy and high load capacity. Alternative suitable bearing types includes but are not limited to double-row angular contact ball bearings, axial roller bearings, crossed-roller bearing, and combined axial-radial bearings.

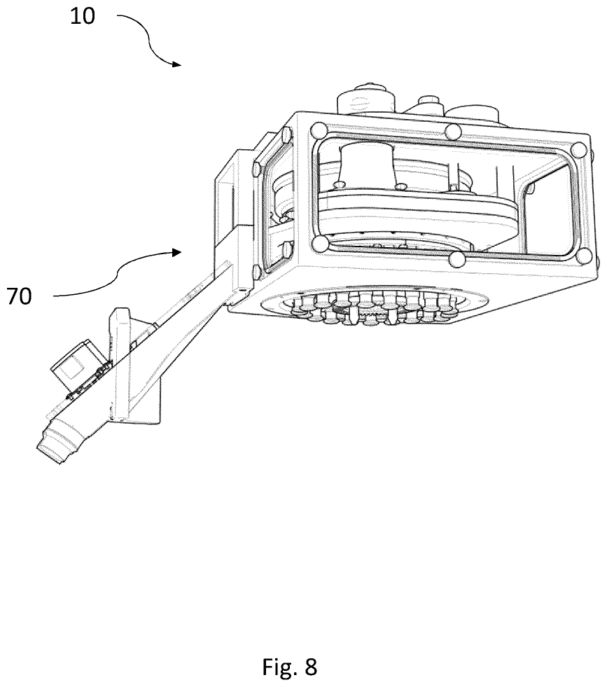

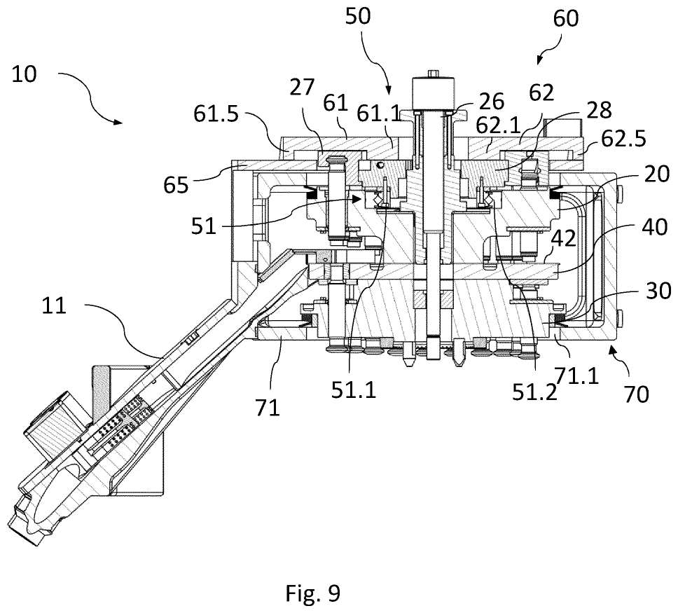

FIG. 10A shows a cross-sectional view of the tablet press 1 in a further embodiment of the invention. This embodiment differs from that of the first and second embodiments shown in FIGS. 1 to 9 in that the non-rotating part comprises a spacer 128, which has an outer diameter enclosed inside the pitch p in the radial direction r, and which is furthermore connected to a stationary part of a bearing assembly 150, namely the radially outer part 151.2 which is the stationary part in this embodiment, while the radially inner part 151.1 is rotating. Thus, the first ends, here represented by the first end 161.1 of the first arm 161, of the arms 161, 162 is connected to the spacer 128.

FIG. 10B shows a cross-sectional view of the tablet press 1 in a further embodiment of the invention. This embodiment differs from that of the first and second embodiments shown in FIGS. 1 to 9, and from the embodiment of FIG. 10A, in that the first ends, here represented by the first end 161.1 of the first arm 161, of the arms 161, 162 are directly connected to the stationary part of a bearing 151 of the bearing assembly 150, in particular the radially outer part 151.2. As in the embodiment of FIG. 10A, the radially outer part 151.2 is stationary. Contrary to the first and second embodiments, and the embodiment of FIG. 10A, the separate stationary spacer is removed.

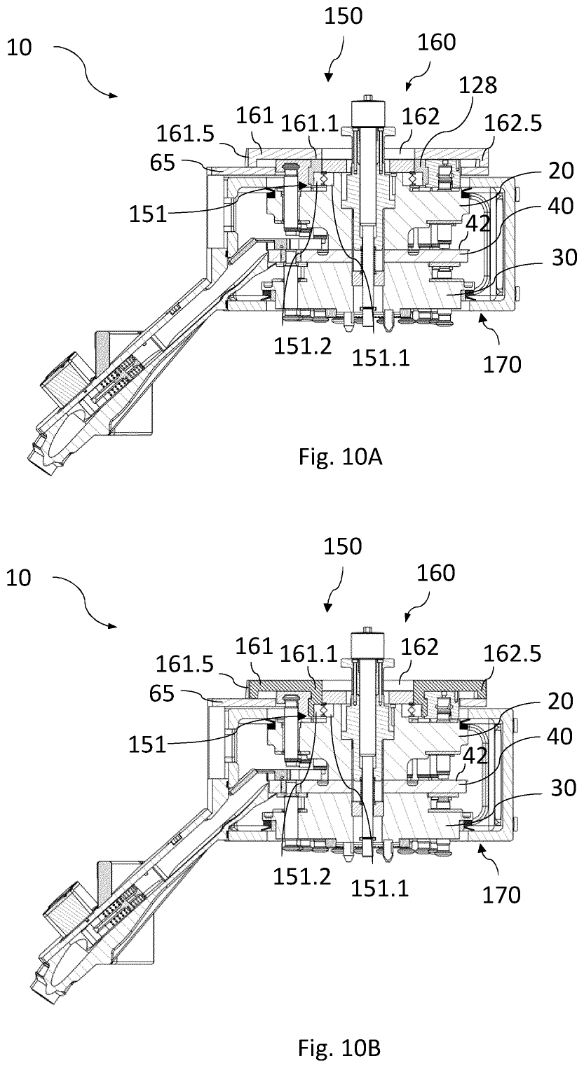

FIG. 11 shows a cross-sectional view of the tablet press 1 in a further embodiment of the invention. This embodiment differs from that of the first and second embodiments shown in FIGS. 1 to 9 in that the carrier plate 65 and the connection element form a one-piece element. Here, the connection element comprises a stepped inner ring 267, said ring 267 being connected to the top cam 27 of the turret 10.

The provision of a connection between the suspension device 60 and a non-rotating part inside the pitch p entails that the linear speed is lower than at positions further outwards in the radial direction. In this way, heating of the parts during operation is kept to a minimum, and in turn, accuracy in the position of the auxiliary components is retained.

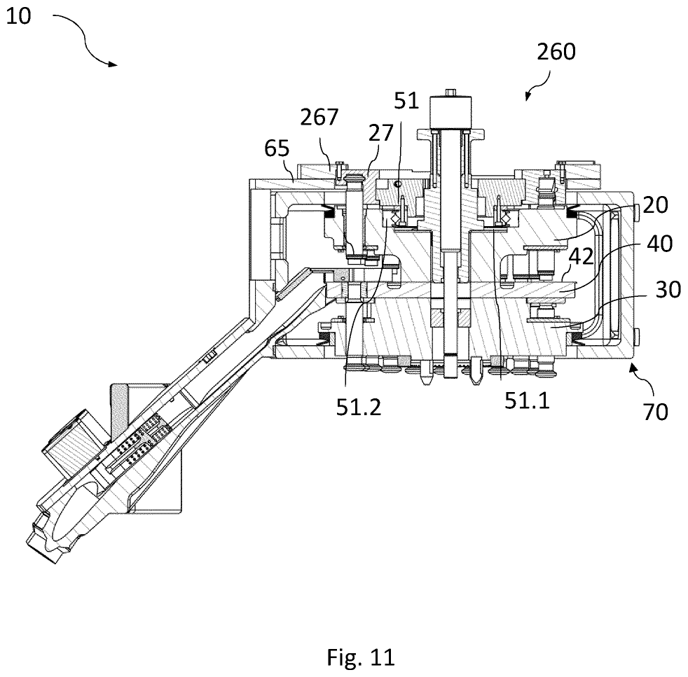

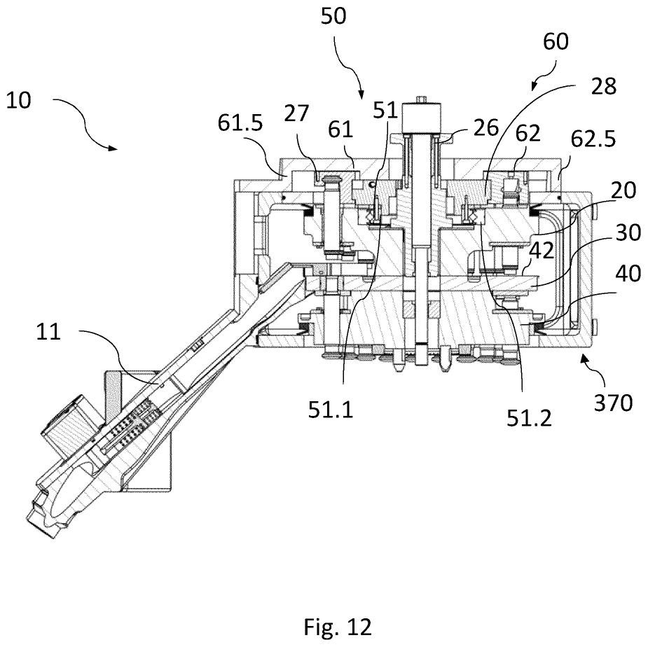

FIG. 12 shows a cross-sectional view of the tablet press 1 in a further embodiment of the invention. This embodiment differs from that of the first and second embodiments shown in FIGS. 1 to 9 in that the enclosure 370 connected to the suspension device 60 is a one-piece element. FIG. 13 shows a perspective view from below of the tablet press in the embodiment of FIG. 12. This one-part embodiment allows for improved flexibility in the design of the enclosure 370, which may for instance formed with a rounded shape inside and a seamless construction, increasing greatly the cleanability. This embodiment can be made of a plastic material, or welded or glued steel, possibly with stainless steel sub-components.

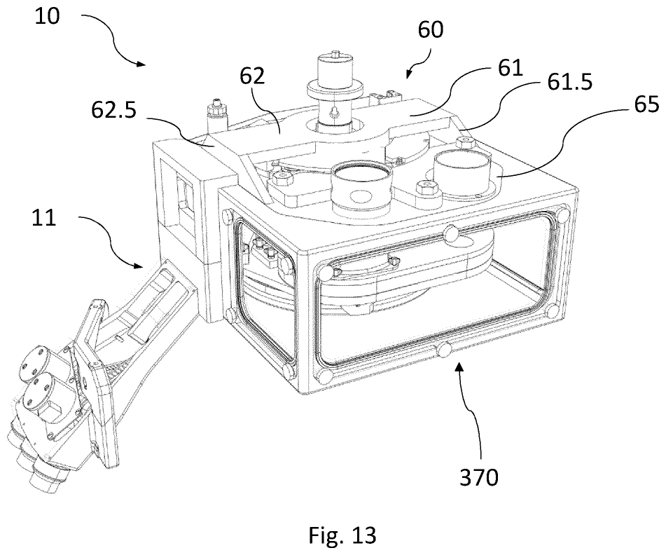

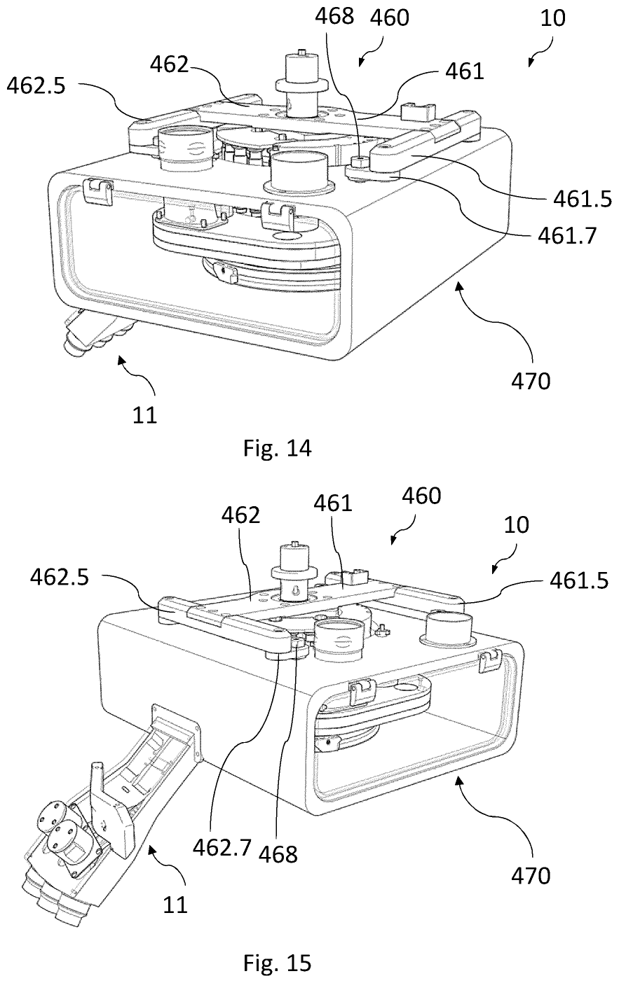

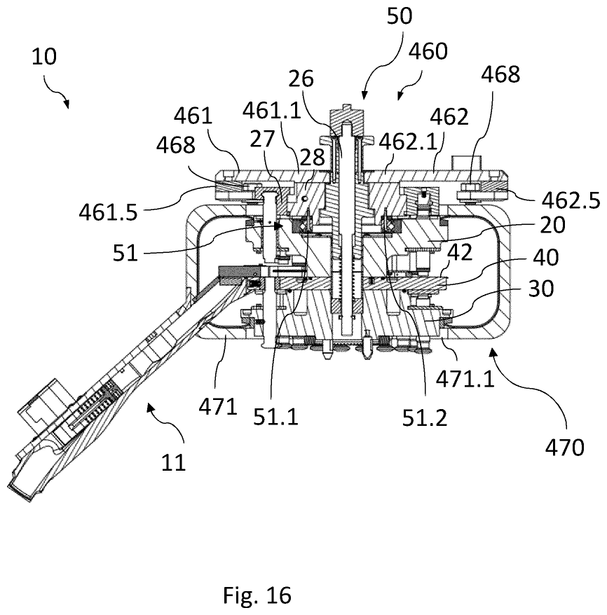

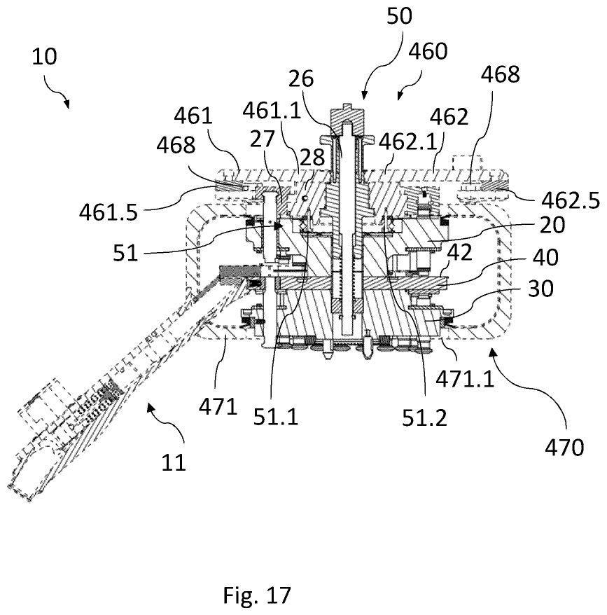

FIGS. 14 and 15 each show a perspective view from a side of an embodiment of the tablet press 1 in a further embodiment of the invention. FIG. 16 shows a cross-sectional view of the tablet press 1 in the embodiment shown in FIGS. 14 and 15. FIG. 17 shows a cross-sectional view of the tablet press 1 in the embodiments shown in FIGS. 14-16. In FIG. 17, the non-rotating parts of the embodiment of the tablet press 1 are indicated by dashed lines The embodiment differs from that of the first, second, and third embodiments shown in FIGS. 1-13 in that suspension device 460 comprises level adjustment devices 468. Like suspension devices 60, 160, 260, the suspension device comprises first and second arms 461, 462. The first 461 and second 462 arms each comprise a respective first portions 461.1 and 462.1 and a respective connection portion 461.5, 462.5. The first portions 461.1, 462.1 may be similar or identical to and/or may comprise any feature described in relation with first portions 61.1, 161.1 and 62.1, 162.1, respectively. Correspondingly, and connection portions 461.5, 462.5 may be similar or identical to and/or may comprise any feature described in relation with connection portions 61.5, 161.5 and connection portion 62.5, 162.5, respectively.

Suspension device 460 may further comprises second portions corresponding to, similar to and/or identical to second portions 61.2, 161.2 and 62.2, 162.2, respectively.

In the embodiment shown in FIGS. 14-17, the level adjustment devices 468 are configured to adjust a position of at least one of the auxiliary components in the axial (a) direction. The level adjustment devices may alternatively or additionally be configured to adjust a position of the at least one of the auxiliary components in the radial direction (r).

Alternatively or additionally, the level adjustment devices 468 may be configured to allow an adjustment of a position of at least one of the auxiliary components in the axial (a) and/or radial direction (r).

The level adjustment devices 468 may allow an adjustment of the position of the at least one of the auxiliary components relative to suspension device 460 and/or first 461 or second arms 462. Alternatively or additionally, the level adjustment devices 468 may allow an adjustment relative to one or more rotating components of turret 10.

Specifically, in the embodiment shown in FIGS. 14-17, the level adjustment devices 468 are configured to adjust a level of the at least one of the auxiliary components relative to a top surface 42 of the die disc 40 of the turret 10. As illustrated by FIGS. 16 and 17, the level of the enclosure 470 and the tablet chute 11, which are suspended from the suspension device 460, can be adjusted in axial direction by the level adjustment devices 468. Thereby, the top surface 42 of the die disc 40 can be considered a reference point for the auxiliary components. Alternatively or additionally, the level adjustment devices 468 may be configured to adjust a level in an axial and/or radial direction of the at least one auxiliary device relative to another rotating part, such as a rotating part rigidly connected to the die disc 40. Correspondingly, level adjustment devices 468 may be configured to allow an adjustment relative to a rotating part, such as the top surface 42 of the die disc 40, relative to a non-rotating part, such as suspension device 460, or, where a non-rotating and a rotating part are connected by a bearing, to both parts, such as both the top surface 42 and the suspension device 460.

In the embodiment shown in FIGS. 14-17, the level adjustment devices 468 comprise one or more threaded portions configured to adjust a level of the at least one of the auxiliary components in the axial direction a. In the embodiment shown in FIGS. 14-17, each of the level adjustment devices 468 comprises a screw with a threaded portion for adjusting the level of the at least one auxiliary component. In other embodiments, each level adjustment devices may comprise a threaded portion and/or may be or comprise a screw, a nut, and/or a bolt for adjusting the level of the at least one auxiliary component. In the embodiment shown in FIGS. 14-17 a corresponding threaded portion is provided in suspension device 460. In other embodiments, however, a nut with a thread may be provided to as to provide a threaded engagement with level adjustment devices 468 in a well-known manner.

The level adjustment devices 468 are arranged in the respective connection elements 461, 462 of the suspension device 460. Specifically, each level adjustment device 468 is arranged in respective adjustment portions 461.7, 462.7 of the first 461 and second arms 462, respectively. The adjustment portions 461.7, 462.7 may be connected to, such as rigidly connected to or formed integrally with, first 461 and second arms 462, or removably connected to first 461 and second arms 462, e.g. by fastening means such as screws and/or bolts. In the embodiment shown in FIGS. 14-17, the adjustment portions 461.7, 462.7 are removably connected to connection portions 461.5, 462.5, respectively.

In the embodiment shown in FIGS. 14-17, four level adjustment devices 358 are provided, two of these being arranged in a respective adjustment portion 461.7 of the first arm 461, and the other two being arranged in a respective adjustment 462.7 of the second arm 462. In this embodiment, the level adjustment allows an adjustment of enclosure 470 and tablet chute 11 in the axial direction a. Each of the level adjustment devices are configured to allow the adjustment of the auxiliary components including the enclosure and tablet chute 11 in the axial direction a. Alternatively or additionally, each of the level adjustment devices 468 may allow for an adjustment in a radial direction.

It will be appreciated that fewer or more adjustment devices may be provided in other embodiments allowing for adjustment of enclosure 470 and/or any further auxiliary component.

Enclosure 470, similarly to enclosures 70 comprises a bottom 471 and an aperture 471.1. The enclosure 470 may comprise any feature disclosed or described in relation with enclosure 70 and 370. Correspondingly, enclosures 70, 370 may be used with level adjustment devices 468 of the embodiments shown in FIGS. 14-17.

### LIST OF REFERENCE NUMERALS

1 rotary tablet press
2 press housing
3 frame
4 outer lining
5 drive section
6 compression section
7 bottom frame
8 accessory section
9 top frame
10 turret
11 tablet chute
12 feeder
13 powder inlet tube
14a scraper
15 ejection finger
20 top punch guide
21 cap
22 cap
23 cap
24 display
25 top punch
26 shaft
27 top cam
28 disc
30 bottom punch guide
35 bottom punch
40 die disc
42 die disc top surface
41 bore
45 die
50 bearing assembly
51 bearing
51.1 radially inner part
51.2 radially outer part
60 suspension device
61 first arm (connection element)
61.1 first end of first arm
61.2 second end of first arm
61.5 inclined connection portion
62 second arm (connection element)
62.1 first end of second arm
62.2 second end of second arm
62.5 inclined connection portion
63 transition portion (between first arm 61 and second arm 62)
64 aperture
65 carrier plate
65.1 bracket
65.2 suspension plate
66 clamping part
66.1 rod
70 enclosure
71 bottom
71.1 aperture
128 spacer
150 bearing assembly
151 bearing
151.1 radially inner part
151.2 radially outer part
160 suspension device (further embodiment)
161 first arm (connection element)
161.1 first end of first arm
161.2 second end of first arm
161.5 connection portion
162 second arm
162.5 connection portion
260 suspension device (still further embodiment)
267 suspension connection
370 enclosure (further embodiment)
460 suspension device (yet further embodiment)
461 first arm (connection element)
461.1 first end of first arm
461.5 connection portion
461.7 adjustment portion
462 second arm (connection element)
462.1 first end of first arm
462.5 connection portion
462.7 adjustment portion
468 level adjustment device
470 enclosure (still further embodiment)
471 bottom
471.1 aperture
α axial direction
r radial direction
p pitch

What is claimed is:

1. A rotary tablet press comprising:
a housing including a compression section, a turret including a die disc, a top punch guide, a bottom punch guide, and a plurality of punches, wherein one or more of the die disc, the top punch guide, the bottom punch guide, and the plurality of punches are rotatable parts,
wherein the turret defines an axial direction (a) and a radial direction (r), the punches being arranged at a predefined radius defining a pitch (p) of the turret, the turret being positioned in the compression section in a position of use of the rotary tablet press,
wherein the rotary tablet press further comprises a number of auxiliary components,
wherein the rotary tablet press comprises a support assembly for providing support to at least one of the auxiliary components of the rotary tablet press in one or more of the axial or radial direction,
wherein the support assembly comprises a suspension device positioned above the top punch guide of the turret, as seen in the axial direction,
wherein the suspension device comprises a carrier plate and at least one connection element connecting the carrier plate to at least one non-rotating part of the turret, the at least one non-rotating part being configured to be stationary relative to the rotatable parts when the rotatable parts rotate, and
wherein a plurality of auxiliary components suspended from the carrier plate of the suspension device.

2. The rotary tablet press according to claim 1, wherein the rotatable parts are configured to rotate about a rotational axis, the rotational axis extending in the axial direction (α).

3. The rotary tablet press according to claim 1, wherein the turret further comprises a shaft configured to drive the rotatable parts into rotation.

4. The rotary tablet press according to claim 1, wherein the at least one non-rotating part comprises a spacer, whose outer diameter enclosed inside the pitch (p) in the radial direction (r), the spacer being interposed between a bearing assembly and the at least one connection element, as seen in the axial direction.

5. The rotary tablet press according to claim 4, wherein the spacer comprises a stationary disc, whose outer diameter is enclosed inside the pitch (p) in the radial direction (r), the disc being interposed between a bearing assembly and the connection element, as seen in the axial direction.

6. The rotary tablet press according to claim 5, wherein the bearing assembly comprises a bearing with a radially inner part and a radially outer part, wherein the radially inner part of the bearing is connected to the spacer or stationary disc and the radially outer part is configured to cooperate with the top punch guide.

7. The rotary tablet press according to claim 1, wherein the at least one non-rotating part of the turret comprises a non-rotating part of a bearing assembly, which is positioned to interact with at least one rotating part of the turret inside the pitch (p) in the radial direction (r).

8. The rotary tablet press according to claim 7, wherein the bearing assembly comprises a bearing with a radially inner part and a radially outer part, wherein the non-rotating part of the bearing assembly comprises the radially outer part.

9. The rotary tablet press according to claim 7, wherein the at least one connection element includes at least one arm extending in the radial direction and having a first end and a second end, and wherein the first end of the at least one arm is positioned substantially at the radial position of the bearing assembly.

10. The rotary tablet press according to claim 9, wherein the first end of the at least one arm is connected to the radially outer part of the bearing via a spacer or directly.

11. The rotary tablet press according to claim 9, wherein the at least one arm includes a first arm and a second arm positioned radially opposite relative to each other, wherein the first arm and the second arm are connected to each other at a transition portion comprising an aperture, and wherein the aperture is co-axial with the axial direction (α) of the turret.

12. The rotary tablet press according to claim 9, wherein the carrier plate extends to the outside of the second end of the at least one arm.

13. The rotary tablet press according to claim 9, wherein the carrier plate is connected to the first arm and to the second arm at the second end of the first arm and the second arm, respectively.

14. The rotary tablet press according to any of the claim 9, wherein the carrier plate is formed integrally with the first arm and the second arm of the corresponding connection element of the suspension device, and wherein an outer connection portion is provided, respectively, such that the carrier plate is located below the connection element, as seen in the axial direction, the carrier plate being preferably provided at a distance from a lower face of an intermediate portion of each arm of the corresponding connection element such that an axial gap is formed between an upper face of the carrier plate and the lower face of the intermediate portion of each arm.

15. The rotary tablet press according to claim 1, wherein the suspension device comprises a clamping plate configured to cooperate with the carrier plate.

16. The rotary tablet press according to claim 1, wherein the at least one non-rotating part comprises a top cam of the turret.

17. The rotary tablet press according to claim 16, wherein the carrier plate and the at least one connection element, the element comprising a stepped inner ring, form a one-piece element.

18. The rotary tablet press according to claim 1, wherein the suspension device comprises one or more level adjustment devices configured to adjust a position of at least one of the auxiliary components in one or more of the axial direction (α) or the radial direction (r).

19. The rotary tablet press according to claim 18, wherein the one or more level adjustment devices comprise one or more threaded portions configured to adjust a level of the at least one of the auxiliary components in the axial direction.

20. The rotary tablet press according to claim 18, wherein the one or more level adjustment devices are arranged in the at least one connection element of the suspension device.

21. The rotary tablet press according to claim 1, wherein the plurality of auxiliary components suspended from the suspension device comprises any combination of the following components: a tablet chute; at least one feeder; a powder inlet tube; a scraper; an extraction nozzle; an ejection finger; a recuperation finger; and a top cam.

22. The rotary tablet press according to claim 1, wherein an enclosure is connected to the suspension device, the enclosure surrounding at least one of the top punch guide, the die disc, or the bottom punch guide.

23. The rotary tablet press according to claim 22, wherein the enclosure connected to the suspension device is a one-piece element.

24. The rotary tablet press according to claim 1, wherein the enclosure comprises a bottom, the bottom comprising an aperture encircling the bottom punch guide.
